(19) United States
(12) Patent Application Publication
(10) Pub. No.: US 2008/0258676 A1
(43) Pub. Date: Oct. 23, 2008

(54) Toy vehicle capable of collecting solar power

(75) Inventor: Wen-Chang Lin, Kaohsiung Hsien (TW)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Yu Chuan Technology Enterprise Co., Ltd., Kaohsiung Hsien (TW)

(21) Appl. No.: 11/827,483

(22) Filed: Jul. 11, 2007

(30) Foreign Application Priority Data
Apr. 17, 2007 (TW) 096206129

(51) Int. Cl. H02J 7/00

(52) U.S. Cl. 320/101; 446/462

(57) ABSTRACT

A toy vehicle includes axles disposed rotatably on a base plate, and wheels mounted respectively on ends of the axles. A drive unit is mounted on the base plate and includes a first gear sleeved fixedly on a motor shaft of a motor and meshing with a second gear sleeved fixedly on one axle. A solar power collecting plate is mounted on the vehicle body for converting solar power into electrical energy that is used to charge a rechargeable battery set mounted on the base plate. A power switch is mounted on the base plate for controlling electrical connection between the rechargeable battery set and the motor so as to permit supply of electrical power from the rechargeable battery set to the motor when in an ON state.

### BACKGROUND OF THE INVENTION

1. Field of the Invention

The invention relates to a toy vehicle, more particularly to a toy vehicle capable of collecting solar power.

2. Description of the Related Art

FIG. 1 illustrates a conventional toy car 1 that includes a car body 11, a base plate 111 mounted with two axles 121, 122, each of which is mounted with two wheels 123, a motor 131 for driving a first gear 133 sleeved fixedly on a motor shaft (not shown) and for further driving a second gear 132 sleeved fixedly on the axle 121 and meshing with the first gear 133, two non-rechargeable batteries 14 for supplying electrical energy, and a power switch 15 connected electrically to the non-rechargeable batteries 14 and the motor 131 and operable so as to control electrical connection between the non-rechargeable batteries 14 and the motor 131. Therefore, when the power switch 15 is operated in an ON state, the batteries 14 are connected electrically to the motor 131 such that the electrical energy from the batteries 14 is supplied to the motor 131.

In such a configuration, since the non-rechargeable batteries 14 are merely used to supply the electrical energy, replacement of the batteries 14 is required when exhausted, thereby resulting in inconvenience during use. Moreover, the exhausted batteries are harmful to the environment.

### SUMMARY OF THE INVENTION

Therefore, the object of the present invention is to provide a toy vehicle capable of collecting solar power that can overcome the aforesaid drawbacks of the prior art.

According to the present invention, a toy vehicle comprises:

a vehicle body;

a base unit including a base plate mounted with the vehicle body thereon, a plurality of parallel axles spaced apart from each other and disposed rotatably on the base plate, and a plurality of wheels mounted respectively on ends of the axles;

a drive unit disposed in the vehicle body, mounted on the base plate of the base unit, and including a motor that has a motor shaft, a first gear sleeved fixedly on the motor shaft of the motor, and a second gear sleeved fixedly on one of the axles of the base unit and meshing with the first gear;

a solar power collecting plate mounted on the vehicle body and adapted to convert solar power into electrical energy;

a rechargeable battery set mounted on the base plate of the base unit, and connected electrically to the solar power collecting plate such that the electrical energy from the solar power collecting plate is used to charge the rechargeable battery set; and

a power switch mounted on the base plate of the base unit, connected electrically between the rechargeable battery set and the motor of the drive unit, and operable so as to switch from an OFF state, where the rechargeable battery set is disconnected electrically from the motor of the drive unit, to an ON state, where the rechargeable battery set is connected electrically to the motor of the drive unit such that electrical power from the rechargeable battery set is supplied to the motor of the drive unit.

### BRIEF DESCRIPTION OF THE DRAWINGS

Other features and advantages of the present invention will become apparent in the following detailed description of the preferred embodiment with reference to the accompanying drawings, of which:

FIG. 1 is a partly exploded perspective view of a conventional toy car;

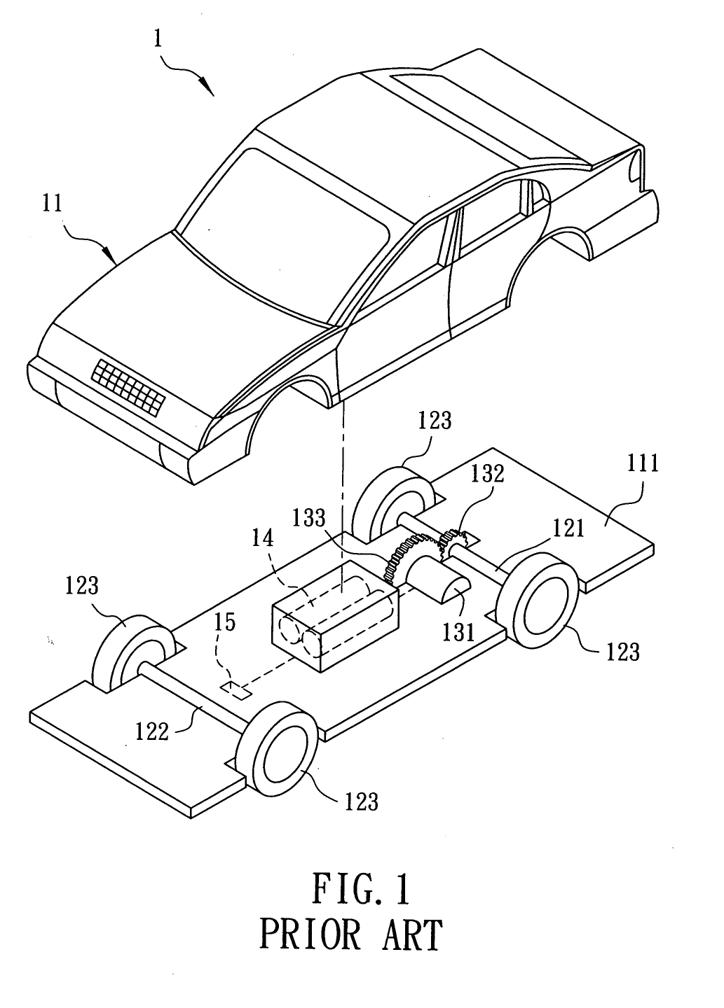

FIG. 2 is a perspective view showing the preferred embodiment of a toy vehicle according to the present invention;

FIG. 3 is a partly exploded perspective view of the preferred embodiment;

FIG. 3a is a schematic circuit block diagram showing the preferred embodiment;

FIG. 4 is a perspective view showing the preferred embodiment with a truck appearance;

FIG. 5 is a perspective view showing the preferred embodiment with a bus appearance; and

FIG. 6 is a perspective view showing the preferred embodiment with a container van appearance.

### DETAILED DESCRIPTION OF THE PREFERRED EMBODIMENT

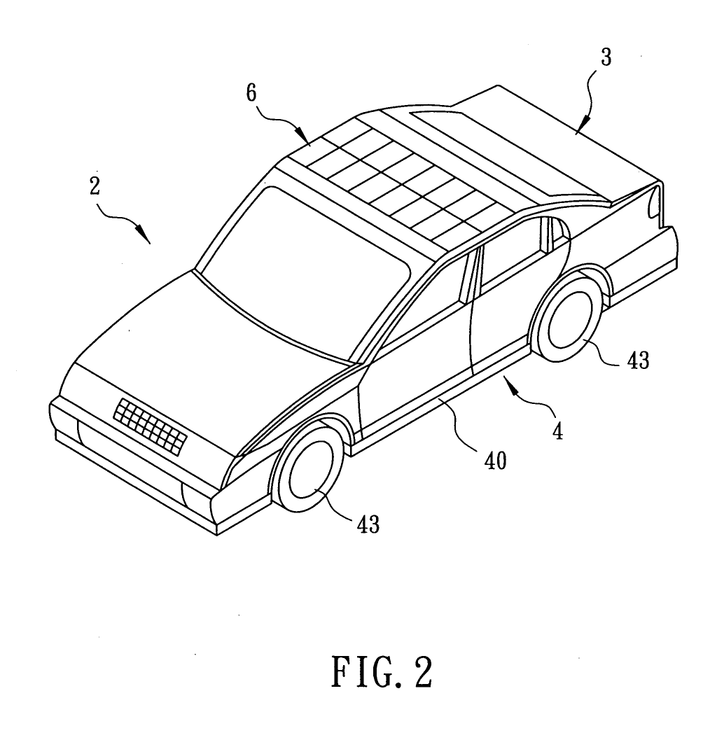

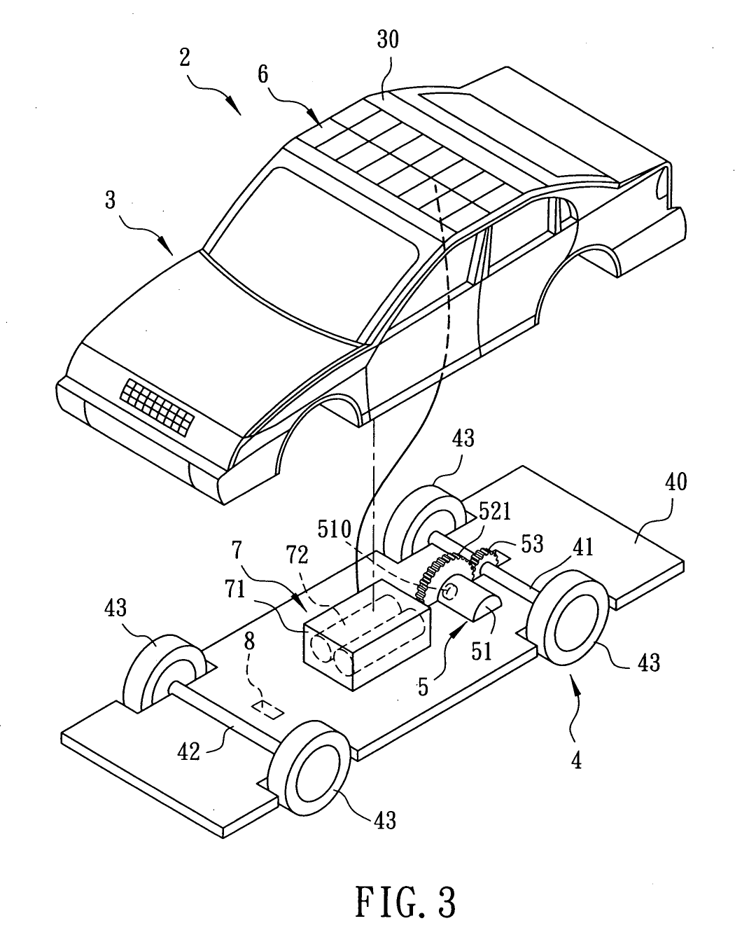

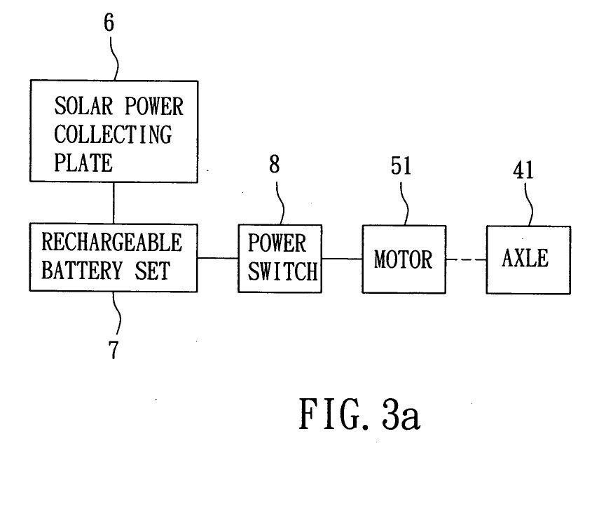

Referring to FIGS. 2, 3 and 3a, the preferred embodiment of a toy vehicle 2 according to the present invention is shown to include a vehicle body 3, a base unit 4, a drive unit 5, a solar power collecting plate 6, a rechargeable battery set 7, and a power switch 8. In this embodiment, the toy vehicle 2 has a car appearance.

The vehicle body 3 is hollow, and has a top side 30.

The base unit 4 includes a base plate 40 mounted with the vehicle body 3 thereon, two parallel axles 41, 42 spaced apart from each other and disposed rotatably on the base plate 40, and a plurality of wheels 43 mounted respectively on ends of the axles 41, 42.

The drive unit 5 is disposed in the vehicle body 3, is mounted on the base plate 40 of the base unit 4, and includes a motor 51 that has a motor shaft 510, a first gear 52 sleeved fixedly on the motor shaft 510 of the motor 51, and a second gear 53 sleeved fixedly on the axle 41 of the base unit 4 and meshing with the first gear 52.

The solar power collecting plate 6 is mounted on the top side 30 of the vehicle body 3, and is adapted to convert solar power into electrical energy.

The rechargeable battery set 7 is mounted on the base plate 40 of the base unit 4, and is connected electrically to the solar power collecting plate 6 such that the electrical energy from the solar power collecting plate 6 is used to charge the rechargeable battery set 7. In this embodiment, the rechargeable battery set 7 includes a battery-mounting seat 71, and two rechargeable batteries 72 mounted in the battery-mounting seat 71. Each rechargeable battery 71 is selected from the group consisting of a lithium battery, a nickel-zinc battery, a nickel-cadmium battery and a hydrocarbon battery.

The power switch 8 is mounted on the base plate 40 of the base unit 4, and is connected electrically between the rechargeable battery set 7 and the motor 51 of the drive unit 5. The power switch 8 is operable so as to switch from an OFF state, where the rechargeable battery set 7 is disconnected electrically from the motor 51 of the drive unit 5, to an ON state, where the rechargeable battery set 7 is connected electrically to the motor 51 of the drive unit 5 such that electrical power from the rechargeable battery set 7 is supplied to the motor 51 of the drive unit 5. As a result, the axle 41 of the base unit 4 is driven by the motor shaft 510 of the motor 51 to rotate, thereby moving the toy vehicle 2.

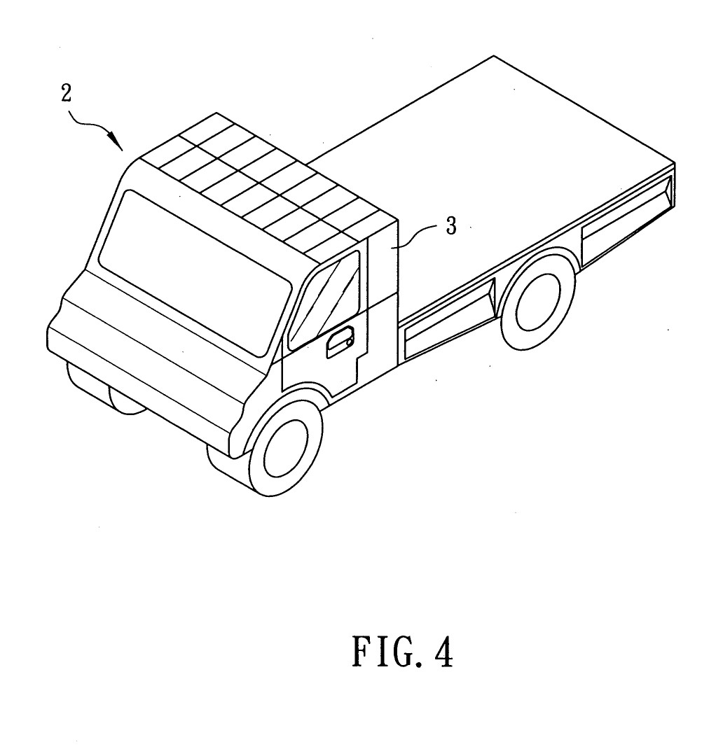

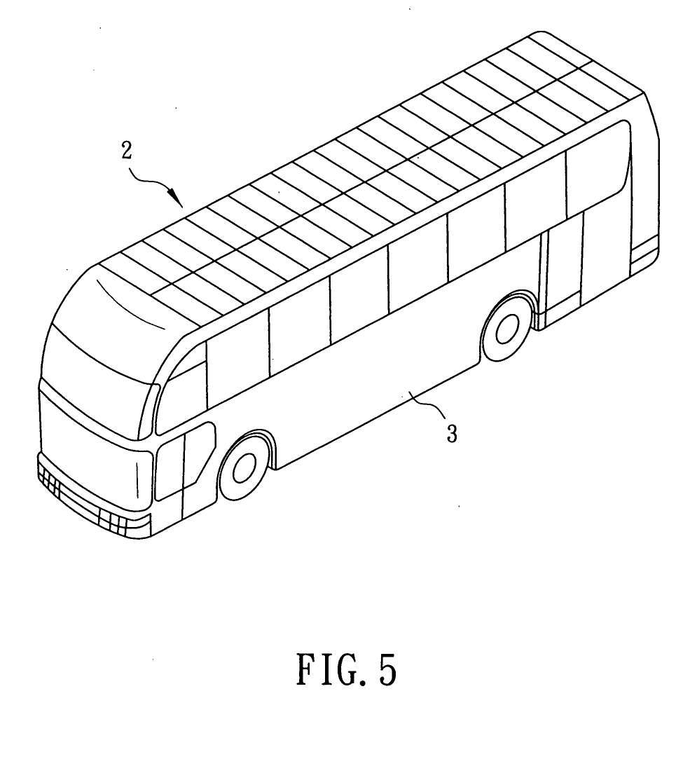

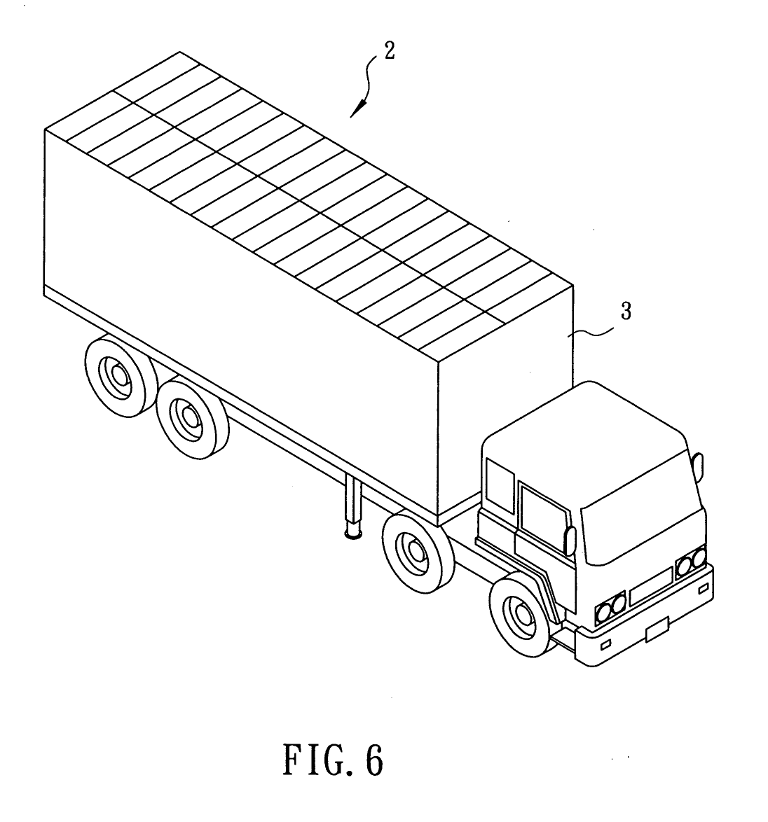

The toy vehicle 2 may be designed to have a truck appearance shown in FIG. 4, a bus appearance shown in FIG. 5, or a container van appearance shown in FIG. 6.

In such a configuration, due to the presence of the solar power collecting plate 6 and the rechargeable battery set 7, the toy vehicle of this invention can obtain sufficient supply of electrical energy therefrom without replacement of exhausted batteries as encountered in the abovementioned prior art, thereby resulting in convenience during use.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

I claim:

1. A toy vehicle comprising:
a vehicle body;
a base unit including a base plate mounted with said vehicle body thereon, a plurality of parallel axles spaced apart from each other and disposed rotatably on said base plate, and a plurality of wheels mounted respectively on ends of said axles;
a drive unit disposed in said vehicle body, mounted on said base plate of said base unit, and including a motor that has a motor shaft, a first gear sleeved fixedly on said motor shaft of said motor, and a second gear sleeved fixedly on one of said axles of said base unit and meshing with said first gear;
a solar power collecting plate mounted on said vehicle body and adapted to convert solar power into electrical energy;
a rechargeable battery set mounted on said base plate of said base unit, and connected electrically to said solar power collecting plate such that the electrical energy from said solar power collecting plate is used to charge said rechargeable battery set; and
a power switch mounted on said base plate of said base unit, connected electrically between said rechargeable battery set and said motor of said drive unit, and operable so as to switch from an OFF state, where said rechargeable battery set is disconnected electrically from said motor of said drive unit, to an ON state, where said rechargeable battery set is connected electrically to said motor of said drive unit such that electrical power from said rechargeable battery set is supplied to said motor of said drive unit.

2. The toy vehicle as claimed in claim 1, wherein said vehicle body has a top side, on which said solar power collecting plate is mounted.

3. The toy vehicle as claimed in claim 1, wherein said rechargeable battery set is selected from the group consisting of a lithium battery, a nickel-zinc battery, a nickel-cadmium battery and a hydrocarbon battery.
